(19) United States
(12) Patent Application Publication
(10) Pub. No.: US 2010/0059159 A1
(43) Pub. Date: Mar. 11, 2010

(54) Tire with Improved Endurance to External Impacts

(75) Inventor: José Merino Lopez, Riom (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges- Paccot (CH)

(21) Appl. No.: 12/521,306

(22) PCT Filed: Dec. 21, 2007
(86) PCT No.: PCT/EP07/11334

§ 371 Date: Nov. 16, 2009

(30) Foreign Application Priority Data
Dec. 28, 2006 (FR) 06/11552

(51) Int. Cl. B60C 17/06

(52) U.S. Cl. 152/517

(57) ABSTRACT

A tire designed to be mounted and pressurized on a vehicle wheel rim that has at least one circumferential seat for a bead belonging to the tire and an outward radial projection in the vicinity of the seat. A circumferential crown is provided with a tread for ensuring contact with the ground. At least one bead has a portion suitable for being mounted on the rim seat. A wall comprising a structure of rubber and reinforcements connects the crown to the bead. The whole formed by these elements defines with the rim an air chamber. At least one protective element is located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire. The protective element is capable of deforming elastically in the direction perpendicular to the tire wall. The protective element is produced using a foam of a rubber-based material with a rigidity greater than 10 MPa (and preferably greater than 25 MPa) and a void ratio of between 15% and 60% (and preferably of between 25% and 40%).

This invention relates to tires mounted and pressurized on the wheel rims of wheeled vehicles. It relates more particularly to arrangements suitable for increasing the resistance of such equipment to the damage to which it is exposed during rolling in the event of impact with obstacles on the ground such as pavements and potholes.

As is known, an inflated tire rolling on the ground is subject under normal conditions of use in terms of speed and loading to impacts against its tread or sidewalls, the frequency and intensity of which are often considerable. It is one of its main functions to absorb them and damp them in such a way that the wheel of the vehicle concerned is not significantly affected by them, either in its movement or in its structural integrity. This ability is an essential reason for their century-long continuance in use on wheeled vehicles.

This ability sometimes however reaches its limits when the conditions of the impact of the tire on an obstacle are such that the impacted wall of the envelope is pushed so far into the air chamber that it either directly meets the wheel rim on which the tire is mounted, or more usually meets another area of the wall of the envelope itself in direct contact with the wheel rim. This often occurs when this rim has, in a conventional way, a projection that is extending radially outwards with respect to the seat proper. A projection of this kind is usually provided in order to prevent the tire bead from being pushed off the rim by axially directed stresses during steering of the wheel. This projection is usually known as the rim hook or rim flange.

In the case referred to above, the impact with the obstacle transmits brief but very high loads, sometimes as much as several tons, to the pinched parts, but also, beyond the wheel rim, to the mechanical suspension attachments of the wheel assembly, and even to the vehicle body. These can seriously damage the suspension members and permanently deform the body of the vehicle. Vehicle designers are therefore forced to provide adequate damping systems to prevent this damage and have to design the body of the vehicle to cope with the normally foreseeable extreme cases.

Unfortunately, even if the vehicle itself is adequately protected, the pneumatic casing subjected to this type of incident can suffer serious consequences from the phenomenon described above. In the section impacted by the shock, the inside wall of the tire is suddenly folded and pinched between the obstacle and the radial projection of the rim. This can rupture the wall, and the tire will then suddenly lose its inflation pressure, which usually means that the vehicle is immediately immobilized. Where the casing has resisted, its components will usually be found to have been damaged by the incident; swellings in the sidewalls or other signs tell the expert that the structure of the casing has been weakened and that its wall could rupture before too long under the repeated flexing of its components, which is of course incompatible with the conditions of safety necessary for driving.

It is an object of this invention to meet these concerns and reduce the threat to a tire impacted by obstacles on the roadway such as potholes or pavement kerbs.

With this in view, the invention relates in particular to a tire designed to be mounted and pressurized on a vehicle wheel rim that has at least one circumferential seat for a bead belonging to the tire and an outward radial projection in the vicinity of the seat, this tire comprising in the conventional way a circumferential crown provided with a tread for ensuring contact with the ground, at least one bead having a portion suitable for being mounted on the rim seat, and a wall comprising a structure of rubber and reinforcements connecting the crown to the bead, the whole formed by these elements defining with the rim an air chamber. In accordance with a principle arrangement of the invention, the tire comprises at least one protective element located in a sector where the tire wall between the crown and the bead may be pinched between the projection and an external obstacle in an area of its circumference, when an impact between the tread and such an obstacle causes closure of the internal cavity of the tire, momentarily creating high compressive stresses perpendicular to the tire wall in the area. The fundamental idea of the invention is to provide the tire with a protective element possessing an overall compressibility with elastic deformability having a high modulus of rigidity in the direction of these stresses, such that it at least partly damps them without simultaneously causing prejudicial stress tangentially to the wall and, in particular to the bond between the rubber and the wall reinforcements, along the reinforcements.

The applicant has found, completely unexpectedly, that the reinforcing threads or cables used, particularly the radial carcass ply reinforcements, in the sidewalls of tires subjected to pinch shocks when rolling on very poor roadways or under relatively extreme conditions of use of the vehicle tend to break under tension due to the stresses generated by the pinching of the casing, or at least tend to suffer elongations beyond their elastic limit, thus giving rise to areas of weakness with respect to fatigue.

Hence, the protective element provided by the invention reduces the tensile stresses in the wall, particularly in the tire reinforcements, around the pinch point, by the appropriate selection of its properties of compressibility, making it possible to at least partly absorb the deformation stresses generated in the direction of the actual pinch loads. Overall or apparent compressibility here means the change of apparent volume of the protective element in the direction of the stress causing this change.

One particularly useful way of producing the protective element is based on the use of an intrinsically incompressible material, but with embodiments that allow this material to be given a certain compressibility in the direction of the applied stress, while keeping the modulus high. Introducing this compressibility allows a change in the apparent or overall volume occupied by the material in question.

A first aspect of the invention is a tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead.

The whole formed by these elements defines with the rim an air chamber. The tire also comprises at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire, the protective element being capable of deforming elastically in the direction perpendicular to the tire wall. The protective element is produced using a foam of a rubber-based material with a rigidity greater than 10 MPa (and preferably greater than 25 MPa) and a void ratio of between 15% and 60% (and preferably of between 25% and 40%).

A second aspect of the invention is a tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead.
   The whole formed by these elements defines with the rim an air chamber. The tire also comprises at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire. The protective element comprises a layer of an incompressible elastically deformable material fixed to the rubber and to the reinforcements of the tire wall in this sector, the layer having a geometry such that cavities form when it is pinched. It is the formation of these cavities between the protective element and the tire wall which it contacts in the event of a pinch (or, where applicable, between two portions of the protective element, if it contacts itself in a pinch) which renders the whole compressible, despite the fact that an incompressible material is being used.

The protective element can also be made using a part in the form of a layer, strip or ply of elastomer rubber (“elastomeric material”) or equivalent material bonded to the rubber and/or to the reinforcements of the tire wall in the area where the tire wall between the crown and the bead may be pinched between the projection and an obstacle external to the tire in response to a violent impact, the part having voids formed throughout its thickness or through part only of its thickness and spaced apart from each other in directions parallel to its surface. The distribution of these voids is such that, if the piece of rubber is pinched radially at a point between an obstacle and an non deformable projection connected to the rim, the rubber around this point can flow elastically and deform by expanding sideways into these voids without passing unacceptable tensile loads to the reinforcements to which the rubber is bonded around this point.

A third aspect of the invention is therefore a tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead.
   The whole formed by these elements defines with the rim an air chamber. The tire also comprises at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire, the protective element being capable of deforming elastically in the direction perpendicular to the tire wall. The protective element comprises a layer of an incompressible elastically deformable material fixed to the rubber and to the reinforcements of the tire wall in this sector, the layer having voids which are spaced apart from each other in directions parallel to its surface through its full thickness or through part of its thickness.

In one embodiment, an incompressible rubber layer is pierced by openings or holes spaced apart from each other, whose distribution and transverse dimensions are such as to allow the requisite transverse expansion in the event of a compressive impact normal to the surface of this part. The layer can thus expand transversely elastically into the voids left by the openings when it is heavily stressed by compressive stresses normal to its surface.

The openings are preferably arranged to give a void ratio of between 30% and 80% and preferably between 45% and 55% in the thickness of the layer.

In another embodiment the layer has thickness variations to create indented areas forming partial voids transversely between raised areas distributed in the rubber layer. The distribution and dimensions of these raised areas and partial voids, or indentations, which separate them, are such as to allow the rubber of the raised areas to expand transversely elastically into the thinner areas when the peaks of the raised areas are heavily stressed by compressive stresses normal to the surface of the sheet.

The indented areas are preferably arranged to provide a void ratio of between 30% and 70% and preferably between 45% and 55% in the thickness of the layer comprising the raised areas.

With regard to the radial location of the protective element, the latter may be positioned on the inside of the tire wall, in one or more areas such as A and B that are vulnerable to pinch shocks. It may also be positioned directly on the inside face of the tire wall. In the latter case it may be formed in all or part of the inner rubber coating which traditionally lines the inside wall of the tire, principally to improve air tightness. As is known, this inner rubber is often based on butyl rubber, a material whose properties of rigidity and hysteresis are suitable for the application envisaged by the invention.

In an embodiment of the invention that is highly advantageous where the protective element comprises a rubber layer on the inside wall of the tire, the surface of the rubber layer has striations whose density and amplitude are determined on the basis of the intrinsic elastic modulus of the constituent rubber to give the layer the desired overall modulus of elastic compressibility.

The rubber layer preferably extends on the inside surface of the sidewall, at least in an area in the vicinity of the tire shoulder and in an area in the immediate vicinity of the bead so that, in the event of the envelope being pinched by the action of an external obstacle, the inside surface of the layer makes contact with itself at two separate locations of the layer where the striations whose peaks are in contact lie across each other in different directions.

In one embodiment, the rubber layer has an overall thickness of more than 1.5 millimeters, and preferably of between 2.5 and 15 millimeters, the height of the striations then being approximately 1.5 millimeters or more.

To implement these arrangements in the case in which the protective element is present in two areas of the inside wall of the tire capable of being pressed together in a pinch shock, the striations whose peaks contact each other must intersect at an angle large enough to ensure that the ribs of one of these areas do not slide into the grooves in the other, which would have the effect of temporarily filling the voids necessary for the expansion or flow of the rubber between the ribs as a means of damping out the tangential stresses within the layer.

With this in mind, the striations may advantageously be organized into one or more networks of lines roughly parallel to an oblique direction, at an angle of between 30° and 60° for instance, and advantageously about 45°, relative to the circumference of the tire. The reason for this is that if the shoulder area is deformed until its inside wall meets the bead area in a pinch shock, the striations of the two contacting areas will intersect roughly at right angles. This assists the operation of the protective element as a damper of pinch stresses. When the striations form a single network on a rubber layer that extends equally across the whole of the inside wall of the tire between the shoulder and bead areas, the toroidal geometry of the tire is such that the condition that the contacting striations should intersect is automatically fulfilled.

In one embodiment the striations are essentially triangular in cross section.

The protective element may be positioned in a sector of the tire wall in the immediate vicinity of the bead, which is an area particularly vulnerable to the pinch effects discussed above.

The protective element may also be positioned in a sector of the tire wall in the vicinity of the shoulder.

One protective element may be located in the vicinity of the bead and one in the shoulder area, or a single protective element can be made in the tire sidewall between the shoulder and the bead.

It has been found to be advantageous, in applications to passenger motor vehicles, to use a protective element with an overall modulus of rigidity (measured at 10% deformation) in the direction of the “pinch” stresses of greater than 0.5 megapascals (MPa) and preferably greater than or equal to 1 MPa.

Of course, the different aspects of the invention can be combined in order to arrive at an especially effective protective element.

Other features and advantages of the invention are found in the description given below with reference to the accompanying drawings, which show, by way of non-limiting examples, various embodiments of the subject of the invention. In the drawings:

FIG. 1 is a cross section taken in a radial plane through a tire on its service rim, with its walls pinched due to a violent head-on impact with an obstacle such as a pavement;

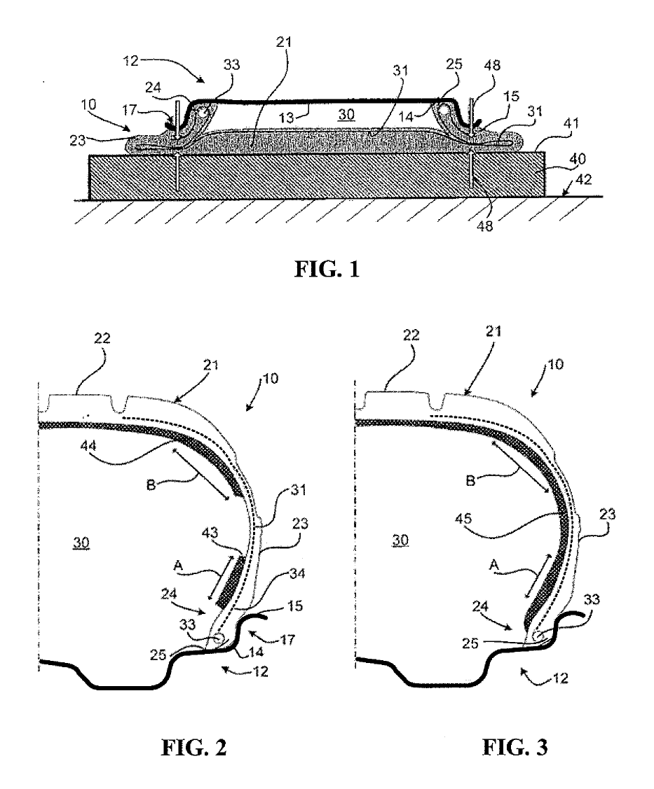

FIGS. 2 to 5 are schematic radial cross sections through a tire mounted on a rim and illustrate four examples of locations for an element for protecting against pinch shocks, according to the invention;

FIG. 6 is a schematic cross section through a protective rubber layer according to the invention, at right angles to its surface;

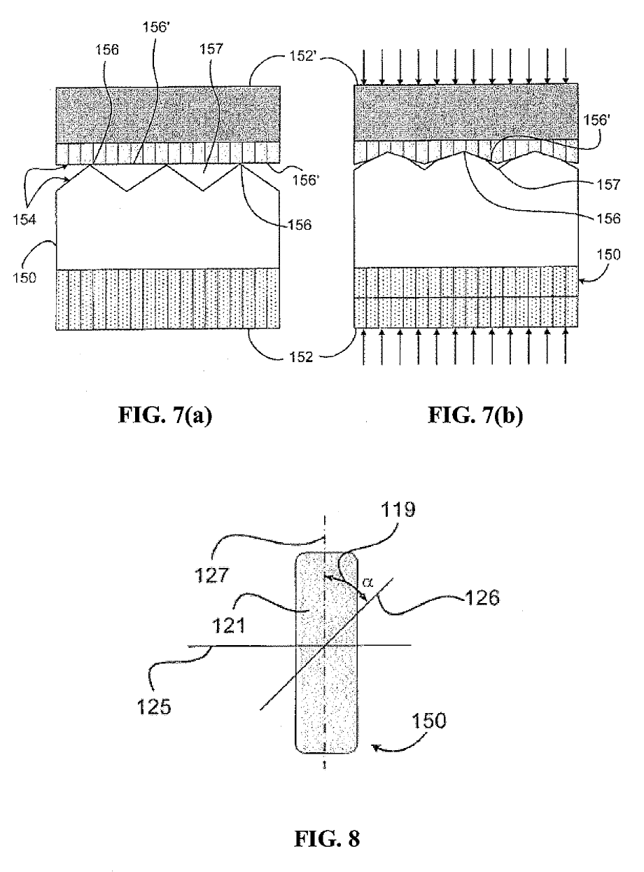

FIGS. 7a and 7b illustrate the working of a protective element according to FIG. 6 when stressed by impact between the tire and an external obstacle;

FIG. 8 is a top view of a tire whose tread is in contact with the ground;

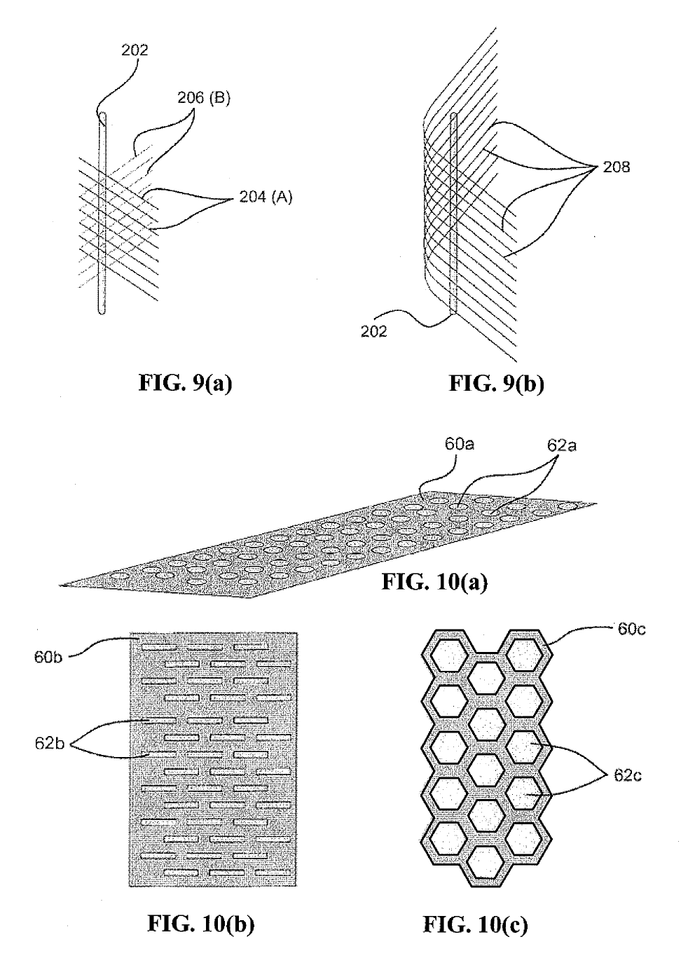

FIGS. 9a and 9b illustrate schematically the arrangement of striations on the surface of a protective element of the type illustrated in FIG. 6;

FIGS. 10a, 10b and 10c are plan views of a rubber layer usable as a protective element in three alternative implementations of the invention; and

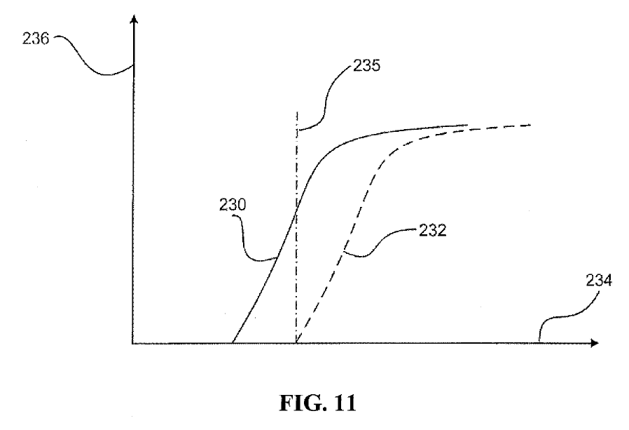

FIG. 11 shows certain results obtained when implementing the invention.

In FIGS. 2 to 5 can be seen a cross section through a tire 10 taken here as an example, mounted on a wheel rim 12. The latter has a rim base 13 (see FIG. 1), typically in a metal such as steel or an aluminium alloy. The rim base 13 has two slightly tapering regions towards its axial edges, each forming a rim seat 14 (indicated in FIG. 2) for accommodating the beads of the tire 10. In this example of a traditional rim, the centre of the rim base contains a well for tire mounting/demounting. At each axial edge the rim is continued in an outward radial direction by a flange forming a projection 17 (FIG. 1) which is curved axially towards the outside with a flange top 15 at the point that is furthest from the wheel axis.

The tire 10 conventionally comprises a crown 21 with a tread 22 on its radially outward side. Each axial edge of the crown 21 is connected by a sidewall 23 to a respective bead 24 having a slightly tapering inward radial face forming a portion of tire 25 which, when mounted, sits on its respective rim seat 14. A carcass ply, shown schematically as 31 in FIG. 2, extends within the wall of the tire from the crown 21 to the bead 24, where it is anchored by its corresponding end. In the example illustrated, it is anchored by turning this end up around a bead core 33. The turn-up 34 of the carcass ply forms an “upturn” portion which is laid against the “incoming” portion of the carcass. The carcass ply is formed very conventionally by the juxtaposition of reinforcing threads or cables of steel embedded in rubber to which they strongly adhere and aligned in the radial direction all the way around the tire. The tire defines, directly with the rim base in this example, an air chamber 30 capable of taking air up to an inflation pressure of several bar for the purpose of supporting and transmitting traction and braking loads, steering, rolling comfort and protection of the vehicle by damping out the impacts of obstacles which it is likely to encounter on the ground.

FIG. 1 illustrates what takes place when the tire 10 on its rim 12 meets an obstacle, shown here as a pavement kerb for example, which rises above the plane of the ground 42 at right angles to the direction of travel of a vehicle equipped with this tire. In the position shown in FIG. 1, the obstacle is struck so violently that the air chamber 30 closes completely at one point of its radial section. The edge 41 of this kerb has just been struck by the tread 22 and the crown of the tire has been smashed violently back against the pressure of the inflation air until its inside face meets the inside wall of the bead on the side away from the top 15 of the rim hook or rim flange 17. In the absence of any possibility of significant radial flexion of this rim flange, the wall of the tire crushed by the impact is effectively pinched powerfully between the projection represented by this rim flange and the kerb. Under the effect of the compression, the wall of the tire axially remote from the pinch point is folded back on itself. This creates acute bending in the reinforcing cables of the carcass at this bent edge and in the rubber layers coating these reinforcements. The corresponding deformations can permanently damage these materials. Even more seriously, the rubber layers directly present in the pinch area illustrated by the arrows 48 are very highly compressed but have no possibility of deforming in this direction. Their intrinsically incompressible nature prevents them from reducing their thickness other than by expanding in the perpendicular directions, that is tangentially with respect to the contacting walls and with respect to the reinforcing threads or cables embedded in the rubber. Owing to the excellent mechanical bond between the rubber layers and the reinforcements forming the tire wall structure, the tendency to tangential deformation of the rubber layers is opposed by the resistance of the reinforcements to their elongation. When the stresses acting on these reinforcements are so high that they exceed the elastic limit of these reinforcements, the latter deform plastically before finally breaking.

Examination of FIG. 1 will make it clear that two areas of the tire wall play an especially crucial role in the phenomenon described above. These are a first area indicated by arrow A in FIGS. 2 to 4, and an area indicated by arrow B in FIGS. 2, 3 and 5. Area A corresponds to the part of the inside face of the tire wall that comes immediately after the bead in the outward radial direction. Area B corresponds to the part of the inside face of the wall that lies in the shoulder section of the tire, that is towards the junction between the sidewall and the crown.

In the example shown in FIG. 2, areas A and B of the inside face of the wall 23 are both provided with a rubber coating such as a circumferential strip of deformable material 43 and 44 to form a protective element capable of at least partly absorbing the pinch forces without harming the reinforcements of the tire wall.

This property can be obtained in area A by making the rubber strip 43 out of a deformable material whose high modulus of rigidity in compression enables it to absorb these loads by compressing (that is, by reducing its volume in a way that does not, or only to a very little extent, divert the contractions recorded in the direction of the applied stress towards the other directions.

Another option is to make the protective strip in area A from a deformable element that is incompressible but designed to react overall to stresses normal to its surface as a true compressible material and not divert into the other directions the deformation (contraction) which it is undergoing in the direction of the pinching stress. Actual examples of this are discussed below with reference to FIGS. 6 to 10.

In the embodiment shown in FIG. 2, area B has also been provided with a material 44 possessing, intrinsically or globally, the properties mentioned in relation to area A. The conjunction of these two protective elements when they are brought into contact by a pinch shock gives effective protection to the tire wall against this type of incident.

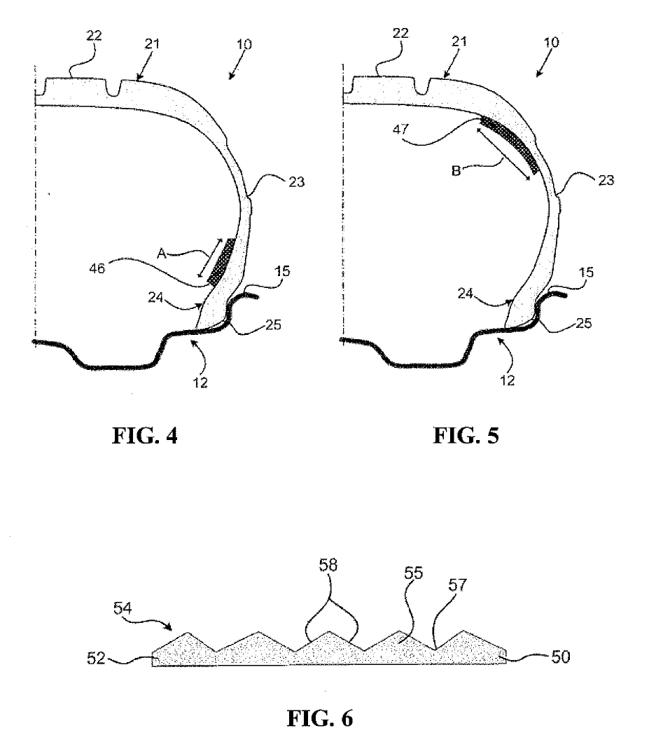

It is of course also possible to cover virtually the entire inside surface of the tire wall, as represented by the layer 45 in FIG. 3, for example to protect the tire even more effectively in the event of an interaction with a non-frontal obstacle or in conditions differing significantly from the example (a frontal impact) illustrated in FIG. 1. Conversely, depending in particular on the severity of the envisaged uses of the tire (for example depending on the condition of the roads), the protective element may be limited to a strip 46 in area A only, close to the bead area (FIG. 4), or configuration B in the shoulder area as illustrated in FIG. 5 at 47, while the variant illustrated in FIG. 4 is the preferred form for this minimal embodiment.

The protective element may also be formed not on the surface of the tire wall but within it, by making an assembly of rubber plies during manufacture (or even, at least in the bead area, on its outer surface).

Placing a protective element on the inner surface of the wall to be protected is of particular advantage for several reasons, especially when its function can be combined with that of a coating already provided in certain traditional tires. For example, an inner rubber layer, as used conventionally for coating the inside face of the tire wall, can be shaped in such a way as to give the desired properties of overall compressibility and, if required, by modifying the thickness of this rubber layer along the sidewall in question depending on the area (A or B in particular) selected.

In very general terms, this inner rubber layer is a sealing rubber selected to ensure best preservation of the tire inflation pressure. For this purpose butyl rubber is advantageously used because of its properties of air impermeability. This material has an intrinsic rigidity under high compression, which enables it to perform the indicated protective function even when it is relatively thin. It also has deformation hysteresis properties that enable it to offer a damping capacity in the transmission of the forces which may be applied to it in a pinching situation.

A compressibility ratio of greater than 10% is desirable in the direction perpendicular to the pinching stress when producing the protective element. It is desirable to have an overall rigidity of the assembly in this direction of greater than 0.6 megapascals (MPa) and preferably greater than 1 MPa. To produce a compressible protective element possessing these characteristics, one possibility is to use an ultra rigid foam, preferably in a rubber material. For example, one possibility is a foam made from a rubber-based material with an intrinsic stiffness greater than 10 MPa (and preferably greater than 25 MPa) and a void ratio of between 15% and 60% (and preferably between 25% and 40%). Another possibility is to use a rubber layer with orifices, bubbles or balls, such as glass balls which break during the impact.

A further possibility is to use a layer of rubber incised throughout its thickness or, to a greater or lesser depth, on one of its faces only. A description is given below of a simple and effective preferred alternative embodiment, with reference to FIG. 6, which shows a cross section through a rubber layer 50 used as a protective element. One face 52 of the layer 50 is normally connected to the inside wall of the tire (not shown here). Its other face 54 is provided with striations 55 parallel to the direction at right angles to the plane of FIG. 6. The striations 55 here have a triangular profile such that the vertices 56 of two adjacent striations are separated by a valley 57 with slopes 58 inclined to a general plane of the layer 50. In this example, the layer 50 is made from an elastomer with a modulus of 1 MPa; the overall thickness of the rubber layer 50 is 3 millimeters; the height of the valleys in the direction perpendicular to the plane of the layer is about 2 mm; the pitch of the repeated striations is 5 millimeters; the profile of the striations is symmetrical, giving a void ratio of 50% in the striated thickness of the layer 50. In practice, a rubber layer with a total thickness greater than 1.5 mm and preferably between 2.5 and 15 millimeters can be used, the height of the striations in this case being at least 1.5 millimeters. The void ratio can be from 30% to 70% and preferably from 45 to 55%.

The rubber layer 50 can be placed on the inside surface of the tire wall, either in a strip in area A and/or a strip in area B, or in a single ply covering not only these two areas but the entire intermediate part of the inner sidewall of the tire. It can be formed by an appropriate configuration of certain areas of a sealing rubber covering the inside wall of the tire.

The striations may have various orientations, including a not necessarily straight path, as seen in a developed plan of the portion of the toroidal surface in which they are formed. However, a preferred orientation is neither radial nor circumferential but at an angle with the direction of a radial line on the inside face of the tire wall, of between 30° and 60° and preferably equal to 45°, for the reasons given below. Thus, if the crown 121 of a tire 110 is projected onto a plane parallel to the axis 125 of the tire and parallel to the ground on which the tire is rolling, as illustrated in FIG. 8, the striations depart from the crown in an oblique direction 126 forming an angle 119 with an equatorial plane 127 perpendicular to the axis 125 of the tire. They intersect the circumferential meridians obliquely in the sidewalls of the tire.

Consider areas A and B which are likely to contact each other in a pinch shock: it is important for correct operation of the protective element that the striations present in these two areas should not slot into each other at the moment when they reach the position shown in FIG. 1 as this would allow the rubber in the peaks of the striations to deform laterally into the valleys when the ridges of the peaks are compressed violently in a pinch shock.

In this regard, FIGS. 7a and 7b illustrate the operation of a striated area in accordance with the invention. In FIG. 7a a rubber test piece 150 with striations 154 on its surface contacts another test piece 150′ whose contact surface 153 also has identical striations oriented parallel to the plane of FIG. 7a. It will be observed that the ridges of the peaks 156 of the striations 154 are just in contact with the ridges such as 156′ of the peaks of the striations on the surface 153′ of the test piece 150′. Contact between the two test pieces therefore takes the form of a grid of bearing points at the intersections of the respective striations. FIG. 7b shows the two test pieces 150 and 150′ when their surfaces which were previously in contact in FIG. 7a are pressed forcibly against each other, as for example in a compression impact on their non-contacting faces 152 and 152′. The points of the contacting peaks collapse under the quasi-instantaneous compressive stresses of around 10 bar generated by the shock. The rubber of the peaks of the test piece 150 is seen to expand sideways and partially fill the valleys 157. The test piece 150′ is stressed in the same way. The ridge of the peak 156′ of this test piece, visible in FIGS. 7a and 7b, deforms at the points of contact with the peaks 156 of the striations of the test piece 150. The total thickness of the test pieces decreases as the stressed rubber deforms and fills the valleys between the peaks of the striations.

FIG. 9a shows schematically the orientation of the striations of two protective layers, one applied to area A and the other to area B on the inside of the tire wall, as they come into contact during an external tire-crushing impact. Reference 202 represents the trace of the rim flange seen in projection on a plane parallel to the tire axis. Parallel lines at 204 illustrate the striations of a protective rubber layer according to the invention in area A next to the bead, on the one hand, while 206 are the striations of a protective layer in area B underneath the shoulder, on the other. It will be seen that the orientation of the striations in areas A and B is such that these lines intersect each other and intersect the direction of the rim flange when they make mutual contact during an external impact. A 45° orientation in opposing directions for the striations 204 and 206 works well. In practice, as described above, it is preferred to select the angle of these striations with the radial direction in the sidewall of the tire between 30° and 60° absolute angle.

FIG. 9b illustrates schematically in the same way as FIG. 9a the case in which the protective rubber layer on the inner sidewall of the tire is a single layer with continuous striations running in a direction of approximately 45° relative to the circumferential direction. It will therefore be seen that, owing to the particular geometry of the tire, the striations 208 of the protective layer making contact in the two areas A and B during a pinch shock intersect naturally in directions that are approximately mutually orthogonal.

FIGS. 10a, 10b and 10c illustrate other embodiments of a rubber layer for making a protective element according to the invention possessing a very high overall radial rigidity in compression for “absorbing” pinch shocks without damaging the tire. The overall compressibility of the rubber layer in the direction of its thickness is increased and adjusted by the provision of suitably distributed openings. As FIG. 10a shows, these openings can be made in the shape of circular wells 62a in a rubber layer 60a. The thickness of the rubber layer covering areas A and B is greater than 1.5 millimeters and preferably from 2.5 to 15 millimeters. Another possibility is to use a rubber layer 60b pierced with openings in the form of slots 62b or other elongate cells (FIG. 10b) or honeycomb cells 62c in a layer 60c (FIG. 10c). In practice, a void ratio of 50% in the plane of the rubber layer works well. It is preferably between 45% and 55% and is not normally less than 30%, while it can be as much as 80% in certain configurations for instance in the case of honeycomb openings as in FIG. 10c, in which case it is advisable to have openings whose transverse dimensions are small, for example approximately 10 millimeters.

Tests conducted on striated rubber protective elements in accordance with the principles indicated above have found a substantial decrease in the number of reinforcements broken when a tire wall is subjected to pinch shocks of varying degrees of violence. The reference curve 230 illustrates the variation in the number of broken reinforcements (on the y-axis 236) in a traditional tire striking a reference obstacle at speeds increasing from 30 to 50 km/h (the x-axis 234). In the same diagram curve 232 shows a large displacement of the area in which damage can occur. This displacement represents a large gain before the first breaks occur. For instance, FIG. 11 shows an area which initially has twenty breaks, reduced to none, as can be seen by the x-coordinates 235.

A method of making striated protective layers on the inside surface of the tire consists in making an uncured form by the traditional techniques with an inner rubber of appropriate thickness, and then using, to cure this form, a counter-molding member, such as a curing membrane or core, suitable for compressing the inner wall of the tire cavity with its other face pressed into a tread mould. The use of curing membranes comprising ribs distributed on their surface to create gas vent channels on the inside surface of the tire during curing is already known. These ribs are not appropriate for making striations in accordance with the invention because they are too small and too widely spaced to have a significant effect. In the present invention it is envisaged that use be made of curing membranes provided with a network of ribs corresponding to the striations to be formed in the inner rubber of the form. This is a very simple way of producing striations corresponding to the invention by means of rather minor changes to the manufacturing tool.

Clearly, the invention is not limited to the examples described and illustrated. Various modifications can be made to it without departing from its scope as defined, in particular, by the accompanying claims.

1.-19. (canceled)

20. A tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead;
the whole formed by these elements defining with the rim an air chamber, the tire also comprising:
at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire, the protective element being capable of deforming elastically in the direction perpendicular to the tire wall,
wherein the protective element is produced using a foam of a rubber-based material with a rigidity greater than 10 MPa (and preferably greater than 25 MPa) and a void ratio of between 15% and 60% (and preferably of between 25% and 40%).

21. A tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead;
the whole formed by these elements defining with the rim an air chamber, the tire also comprising:
at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire, the protective element being capable of deforming elastically in the direction perpendicular to the tire wall,
wherein the protective element comprises a layer of an incompressible elastically deformable material fixed to the rubber and to the reinforcements of the tire wall in this sector, the layer having a geometry such that cavities form when it is pinched.

22. The tire of claim 21, wherein the layer has thickness variations to create indented areas between raised areas in the rubber layer, the distribution and dimensions of which are such as to allow the rubber of the raised areas to expand transversely elastically into the indented areas when the peaks of the raised areas are heavily stressed by compressive stresses normal to the layer.

23. The tire of claim 22, wherein the indented areas are arranged to provide a void ratio of between 30% and 70% in the thickness of the layer comprising the raised areas.

24. The tire of claim 22, wherein the layer is a rubber coating located on the inside face of the tire wall and wherein the surface of the rubber layer has roughly parallel striations whose density and amplitude are selected on the basis of the intrinsic elastic modulus of the constituent rubber to give the layer the desired overall modulus of rigidity in compression.

25. The tire of claim 24, wherein the rubber layer extends on the inside surface of the sidewall, at least in an area in the vicinity of the tire shoulder and in an area in the immediate vicinity of the bead so that, in the event of the envelope being pinched by the action of an external obstacle, the inside surface of the layer makes contact with itself at two separate locations of the layer where the striations whose peaks are in contact lie across each other in different directions.

26. The tire of claim 24, wherein the rubber layer has an overall thickness of more than 1.5 millimeters, the height of the striations then being approximately 1.5 millimeters or more.

27. The tire of claim 24, wherein the striations are essentially triangular in cross section.

28. The tire of claim 21, wherein the layer is a rubber coating located on the inside face of the tire wall.

29. The tire of claim 21, wherein the layer is formed by at least one sector of a sealing rubber on the inside face of the tire wall.

30. A tire designed to be mounted and pressurized on a vehicle wheel rim that has at least one circumferential seat for a bead belonging to the tire and an outward radial projection in the vicinity of the seat, this tire comprising:
a circumferential crown provided with a tread for ensuring contact with the ground;
at least one bead having a portion suitable for being mounted on the rim seat; and
a wall comprising a structure of rubber and reinforcements connecting the crown to the bead;
the whole formed by these elements defining with the rim an air chamber, the tire also comprising:
at least one protective element located in a sector where the tire wall between the crown and the bead could become pinched between the projection and an obstacle external to the tire in response to a violent impact due to the tread meeting this obstacle, causing closure of the internal cavity of the tire in this sector and momentary high compressive stresses perpendicular to the wall of the tire, the protective element being capable of deforming elastically in the direction perpendicular to the tire wall,
wherein the protective element comprises a layer of an incompressible elastically deformable material fixed to the rubber and to the reinforcements of the tire wall in this sector, the layer having voids which are spaced apart from each other in directions parallel to its surface through its full thickness or through part of its thickness.

31. The tire according to claim 30, wherein the layer is pierced by openings spaced apart from each other, whose distribution and transverse dimensions are such as to allow the material of this layer to expand transversely elastically into the voids left by these openings when it is heavily stressed by compressive stresses normal to its surface.

32. The tire according to claim 31, wherein the openings are arranged to give a void ratio of between 30% and 80% in the thickness of the layer.

33. The tire of claim 30, wherein the layer has thickness variations to create indented areas between raised areas in the rubber layer, the distribution and dimensions of which are such as to allow the rubber of the raised areas to expand transversely elastically into the indented areas when the peaks of the raised areas are heavily stressed by compressive stresses normal to the layer.

34. The tire of claim 33, wherein the indented areas are arranged to provide a void ratio of between 30% and 70% in the thickness of the layer comprising the raised areas.

35. The tire of claim 33, wherein the layer is a rubber coating located on the inside face of the tire wall and wherein the surface of the rubber layer has roughly parallel striations whose density and amplitude are selected on the basis of the intrinsic elastic modulus of the constituent rubber to give the layer the desired overall modulus of rigidity in compression.

36. The tire of claim 35, wherein the rubber layer extends on the inside surface of the sidewall, at least in an area in the vicinity of the tire shoulder and in an area in the immediate vicinity of the bead so that, in the event of the envelope being pinched by the action of an external obstacle, the inside surface of the layer makes contact with itself at two separate locations of the layer where the striations whose peaks are in contact lie across each other in different directions.

37. The tire of claim 35, wherein the rubber layer has an overall thickness of more than 1.5 millimeters, the height of the striations then being approximately 1.5 millimeters or more.

38. The tire of claim 35, wherein the striations are essentially triangular in cross section.

39. The tire of claim 30, wherein the layer is a rubber coating located on the inside face of the tire wall.

40. The tire of claim 30, wherein the layer is formed by at least one sector of a sealing rubber on the inside face of the tire wall.

41. The tire of claim 20, wherein the protective element has an overall modulus of rigidity in the direction of the “pinching” stresses of greater than 0.5 MPa.

42. The tire of claim 20, wherein the protective element is positioned in a sector of the tire wall in the immediate vicinity of the bead.

43. The tire of claim 20, wherein the protective element is positioned in a sector of the tire wall in the vicinity of the shoulder.

44. The tire according to claim 42, wherein the protective element is positioned in a section of the tire wall in the vicinity of the shoulder, and wherein the protective element extends over essentially the whole portion of the tire wall between the shoulder and the bead.
